(19) United States
(12) Patent Application Publication
(10) Pub. No.: US 2017/0312933 A1
(43) Pub. Date: Nov. 2, 2017

(54) MACHINING DEVICE FOR WORKPIECES AND METHOD THEREFOR

(71) Applicant: HOMAG HOLZBEARBEITUNGSSYSTEME GMBH, Schopfloch (DE)

(72) Inventors: Volker SCHMIEDER, Mössingen (DE); Stefan FRIESE, Pfalzgrafenweiler (DE); Christian STURM, Sulz am Neckar (DE)

(73) Assignee: HOMAG GMBH, Schopfloch (DE)

(21) Appl. No.: 15/522,963

(22) PCT Filed: Nov. 3, 2015
(86) PCT No.: PCT/EP2015/075599

§ 371 Date: Apr. 28, 2017

(30) Foreign Application Priority Data
Nov. 3, 2014 (DE) 10 2014 222 422.5

(51) Int. Cl. B27C 5/06; B27F 5/12

(52) U.S. Cl. CPC B27C 5/06; B27F 5/12

(57) ABSTRACT

The invention relates to a machining device for workpieces, comprising a first workpiece table that is displaceable along a longitudinal direction and comprising a second workpiece table that is displaceable in the longitudinal direction, wherein the two workpiece tables are arranged spaced apart perpendicular to the longitudinal direction, wherein each of the two workpiece tables comprises clamping elements for clamping a workpiece, and wherein a guide element is also provided, which is arranged aligned perpendicular to the longitudinal direction and is used for the displaceable guidance of a tool element, comprising a first tool element, which is displaceably arranged on the guide element for machining the workpiece, comprising a first manipulator device for gripping and positioning a workpiece into at least one clamping element of one of the workpiece tables or for removing a workpiece from at least one clamping element of one of the workpiece tables.

### TECHNICAL FIELD

The invention relates to a machining device for workpieces, in particular made of wood, plastic or the like, in particular according to the preamble of claim 1, and to a method for operating such a machining device.

### PRIOR ART

Machining devices for workpieces, in particular made of wood, plastic or the like, are widely known in the prior art. Such machining devices serve, for example, to process workpieces made of wood, wood replacement materials, plastic or the like, in which the workpiece is cut to size and contoured on its longitudinal and/or narrow sides. The workpiece can also be provided at designated positions for example with bores, etc. Such workpieces are usable, for example, as components for windows or doors, etc.

DE 101 37 839 A1 discloses a machining device in which two opposite workpiece tables which are movable in the longitudinal direction are provided with a respective clamping device for clamping a workpiece, said clamping devices being oriented in such a manner that they can alternatively clamp and shift an identical workpiece in order to be able to machine the workpiece on its respective longitudinal sides and on the narrow sides. The workpiece is first of all clamped here in a clamping device of a movable workpiece table and machined on one longitudinal side, then the workpiece is reclamped in the clamping device of the other workpiece table and subsequently machined on the other longitudinal side. As a result, the clamping is required in both workpiece tables in order to be able to completely machine the workpiece.

This increases the cycle time and therefore increases the production costs per workpiece.

### SUMMARY OF THE INVENTION, OBJECT, SOLUTION, ADVANTAGES

It is the object of the invention to provide a machining device for workpieces which has increased productivity and is nevertheless constructed simply.

This object with respect to the machining device is achieved with the features of claim 1.

An exemplary embodiment of the invention relates to a machining device for workpieces, in particular made of wood, plastic or the like, with a first workpiece table which is shiftable along a longitudinal direction and with a second workpiece table which is shiftable in the longitudinal direction, wherein the two workpiece tables are arranged spaced apart perpendicularly to the longitudinal direction, wherein each of the two workpiece tables has clamping elements for clamping a workpiece, wherein the clamping elements are designed in such a manner that they have two clamping positions facing each other with respect to the longitudinal direction for clamping a workpiece, and therefore a workpiece can be clamped in the two clamping positions, and wherein furthermore a guide element is provided which is arranged oriented perpendicularly to the longitudinal direction and serves for the shiftable guiding of a tool element, with a first tool element which is arranged shiftably on the guide element, for machining the workpiece, with a first manipulator device for gripping and positioning a workpiece in at least one clamping element of one of the workpiece tables or for removing a workpiece from at least one clamping element of one of the workpiece tables. This machining device permits the machining of a workpiece by means of a tool element and the simultaneous supply or removal of a further workpiece by means of the manipulator device or reclamping by means of the manipulator device in order, for example after machining one longitudinal side, to be able to machine a further longitudinal side of a workpiece. This affords an advantage in terms of time because machining operations, for example in the form of material-removing machining operations and/or in the form of manipulating operations can be carried out isochronously or parallel in terms of time, which increases the machining efficiency and reduces the effective cycle times.

It is also advantageous if a second tool element is provided which is arranged shiftably on the guide element, for machining the workpiece. As a result, two workpieces can also be machined parallel in terms of time. This also reduces the effective cycle time.

Furthermore, it is advantageous if the first tool element and the second tool element are guided shiftably on the guide element in a manner spaced apart from each other in the longitudinal direction. As a result, the first and the second tool element can be arranged and shifted independently of each other on the guide element, and therefore, in particular during any movements of the two tool elements, a collision of said tool elements is avoided.

It is also particularly expedient if the first tool element and the second tool element are guided shiftably on the guide element at the same height in the longitudinal direction. With a collision control, the collision is likewise avoided and the tool elements can be appropriately moved to meet the requirement of machining the respective workpiece.

It is advantageous if the guide element is a gantry or an extension arm on which the first and/or the second tool element are shiftably guided. As a result, the respective tool element can be safely guided, wherein the workpieces can be guided in particular under the extension arm or through the gantry in order to be able to machine said workpieces.

It is also particularly advantageous if the first manipulator device is configured in such a manner that by means of the latter a workpiece can be picked up from a workpiece feed and can be supplied to one of the workpiece tables into a clamping position in at least one clamping element, or that by means of said manipulator device a workpiece can be moved from a first clamping position in at least one first clamping element into a second clamping position in at least one second clamping element, or by means of said manipulator device a workpiece can be removed from a clamping position in at least one clamping element to a workpiece-removing means. The first manipulator device can be formed, for example, with an articulated gripper in order to be able to carry out the respective shifting processes. A first clamping element can be actuable here independently of a second clamping element, or alternatively a first clamping element can be coupled to a second clamping element, and therefore the two clamping elements are actuable together. The clamping elements preferably each point in opposite directions in order to form the receptacles for the tool in a manner facing one another with opposite receiving openings.

It is also advantageous if the first manipulator device is configured in such a manner that by means of the latter a workpiece can be supplied to at least one tool element for machining the workpiece. As a result, additional machining can be carried out, for example, by means of an additional tool assembly which, for example, is not arranged shiftably on the guide device.

It is also advantageous if a machining device according to the invention is provided with at least one third workpiece table which is shiftable along a longitudinal direction and in particular with a fourth workpiece table which is shiftable in the longitudinal direction, wherein the two third and fourth workpiece tables are arranged spaced apart perpendicularly to the longitudinal direction, wherein each of the two third and fourth workpiece tables have clamping elements for clamping a workpiece, wherein the clamping elements are designed in such a manner that they have two clamping positions facing each other with respect to the longitudinal direction for clamping a workpiece, and therefore a workpiece can be clamped in the two clamping positions, and wherein furthermore a second guide element is provided which is arranged oriented perpendicularly to the longitudinal direction and serves for the shiftable guiding of at least one tool element, with a third tool element which is arranged shiftably on the second guide element, for machining the workpiece, with a second manipulator device for gripping and positioning a workpiece in at least one clamping element of either the third or fourth workpiece table or for removing a workpiece from at least one clamping element of either the third or fourth workpiece table. A further increase in efficiency can thus be achieved and the effective cycle time for machining a workpiece reduced or the machining capacity increased.

It is also advantageous if the second manipulator device is the first manipulator device, or that the second manipulator device is an additional manipulator device which is separate from the first manipulator device. As a result, a single manipulator device or alternatively two manipulator devices could undertake the loading of the provided workpiece tables and the moving of workpieces.

According to the invention, it is furthermore advantageous if a fourth tool element is provided which is arranged shiftably on the second guide element, for machining the workpiece. This furthermore increases the efficiency of machining workpieces.

It is also advantageous if the third tool element and the fourth tool element are guided shiftably on the second guide element in a manner spaced apart from each other in the longitudinal direction. As a result, collision-free movability of the third and fourth tool elements during the machining of the workpieces is again achieved.

It is also advantageous if the third tool element and the fourth tool element are guided shiftably on the guide element in a manner spaced apart from each other in the longitudinal direction.

It is particularly advantageous if the second guide element is a gantry or an extension arm on which the third and/or the fourth tool element are shiftably guided.

It is also particularly advantageous if the second manipulator device is configured in such a manner that by means of the latter a workpiece can be picked up from a workpiece feed and can be supplied to either the third or fourth workpiece table in a clamping position in at least one clamping element, or that by means of said manipulator device a workpiece can be moved from a first clamping position in at least one first clamping element into a second clamping position in at least one second clamping element, or by means of said manipulator device a workpiece can be removed from a clamping position in at least one clamping element to a workpiece-removing means.

It is particularly advantageous if a third manipulator device is provided which is configured in such a manner that by means of the latter a workpiece from either the first or second workpiece table can be supplied to either the third or fourth workpiece table, or that by means of said manipulator device a workpiece from either the third or fourth workpiece table can be supplied to either the second or third workpiece table, or that by means of said manipulator device a workpiece can be moved from a first clamping position in at least one first clamping element into a second clamping position in at least one second clamping element, or by means of said manipulator device a workpiece can be removed from a clamping position in at least one clamping element to a workpiece-removing means. As a result, workpieces can be moved between the first or second workpiece table and the third or fourth workpiece table, which further increases the machining efficiency.

It is also particularly advantageous if the workpiece-removing means contains a shute for the workpiece, onto which shute a workpiece can be deposited such that it is removed. The effect achieved by this is that a movable gripper does not have to be provided for removing a machined workpiece, but rather the workpiece can drop out of the clamping position of at least one clamping element and is removed via the shute.

The object with respect to the method is achieved with the features of claim 16.

An exemplary embodiment of the invention relates to a method for operating a machining device, in particular for operating a workpiece, wherein a workpiece can be machined in a clamping position of one of the workpiece tables by a tool element, wherein substantially isochronously therewith a further workpiece can be removed by a manipulator device from one of the workpiece tables or can be supplied to one of the workpiece tables or can be moved in one of the workpiece tables from one clamping position into another clamping position, or can be moved from one of the workpiece tables from one clamping position into another clamping position of another workpiece table, or a further workpiece can be machined in a clamping position of one of the other workpiece tables by means of another tool element. As a result, increased efficiency is achieved.

According to the invention, material-removing machining of the workpiece in the longitudinal direction thereof takes place with a machining device, wherein said machining process can advantageously take place continuously in the complete longitudinal direction of said workpiece. An advantageously single-sided or two-sided longitudinal profiling of the workpiece is therefore brought about here.

Further advantageous refinements of the invention are described by the description below of the figures.

### BRIEF DESCRIPTION OF THE FIGURES

The invention is explained in more detail below on the basis of at least one exemplary embodiment with reference to the figures, in which:

FIG. 1 shows schematically an exemplary embodiment of a machining device according to the invention for workpieces,

FIG. 2 shows schematically a second exemplary embodiment of a machining device according to the invention for workpieces,

FIG. 3 shows schematically a third exemplary embodiment of a machining device according to the invention for workpieces, and

FIG. 4 shows schematically an element for removing a workpiece after machining had taken place.

### PREFERRED EMBODIMENT OF THE INVENTION

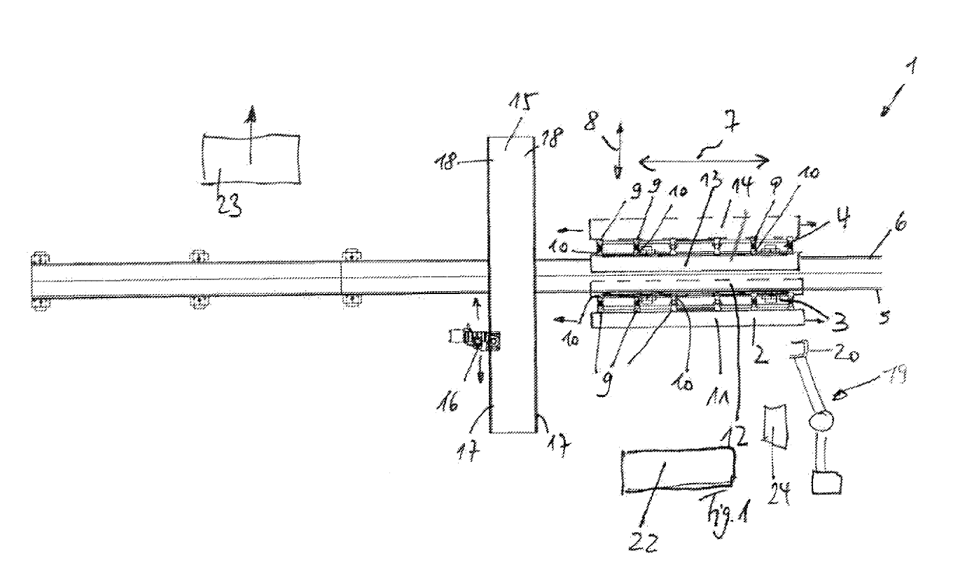

FIG. 1 shows a schematic view of a machining device for machining a workpiece 2, in particular made of wood, plastic or the like.

The machining device 1 has two workpiece tables 3, 4 which are configured and arranged so as to be movable in the longitudinal direction 7 by means of rails 5, 6. For this purpose, at least one advancing device is provided in each case per workpiece table 3, 4, by means of which the shifting and positioning in the longitudinal direction takes place, but which are not shown. The device 1 therefore has a first workpiece table 3 which is shiftable along the longitudinal direction 7 and a second workpiece table 4 which is shiftable in the longitudinal direction 7, wherein the two workpiece tables 3, 4 are arranged spaced apart perpendicularly to the longitudinal direction 7. This is advantageously already brought about by the fact that the rails 5, 6 for guiding the workpiece tables 3, 4 are arranged spaced apart in a direction 8 perpendicularly to the longitudinal direction 7.

Each of the two workpiece tables 3, 4 has clamping elements 9, 10 for clamping a workpiece 2. The clamping elements 9, 10 are arranged spaced apart from each other in the longitudinal direction 7 along the workpiece table 3, 4 in order also to be able to clamp longer workpieces 2 securely at a plurality of points.

The clamping elements 9, 10 are designed here in such a manner that they have two clamping positions 11, 12, 13, facing each other with respect to the longitudinal direction 7 for clamping a workpiece 2, and therefore a workpiece 2 can be clamped in the two clamping positions 11, 12 and 13, 14. In this case, one workpiece 2 per workpiece table 3, 4 can be clamped in one of the clamping positions 11, 12, 13, 14, or it is also entirely possible for two workpieces 2 to be clamped simultaneously in the two clamping positions of a workpiece table 3, 4.

When the discussion here is about one workpiece 2, it is basically also possible for a plurality of workpieces 2 to be clamped next to one another in the longitudinal direction 7 depending on the clamping position 11, 12, 13, if the length of the workpieces 2 is correspondingly short and this plurality of workpieces 2 permits this.

Furthermore, a guide element 15, such as an extension arm or a gantry, is provided which is arranged oriented perpendicularly to the longitudinal direction 7 and serves for the shiftable guiding of a tool element 16. For this purpose, the guide element 15 has a type of rail 17 on which the tool 16 is shiftably guided. The rail 17 is arranged on the one and/or on the other longitudinal side 18 of the guide element 15.

A first tool element 16 is arranged on this guide element 15, and said tool element is designed to be shiftable along the rail 17 by means of an advancing device (not illustrated).

The tool element 16 is, for example, a milling tool with a milling drive and a milling head for machining a longitudinal or narrow side of the workpiece. The tool element 16 can also be a drill head for drilling at least one bore.

Furthermore, a first manipulator device 19 is preferably provided with at least one gripper 20 or with a plurality of grippers 20, for gripping and positioning a workpiece 2 in at least one clamping element 9, 10 of one of the workpiece tables 3, 4 or for removing a workpiece 2 from at least one clamping element 9, 10 of one of the workpiece tables 3, 4. The manipulator device 19 (only illustrated schematically) can have a plurality of grippers 20 which are arranged spaced apart from one another in the longitudinal direction 7 in order advantageously to be able to securely grip and position even long workpieces 2.

This machining device permits a workpiece 2 to be clamped in one of the workpiece tables 3, 4 such that said workpiece 2 can be machined with the tool element 16 while it is entirely also possible at the same time for another workpiece 2 to be moved in the other workpiece table 4, 3 and to be moved, taken away or supplied by the manipulator device 19. As a result, some of the operations can be carried out simultaneously, which saves on time.

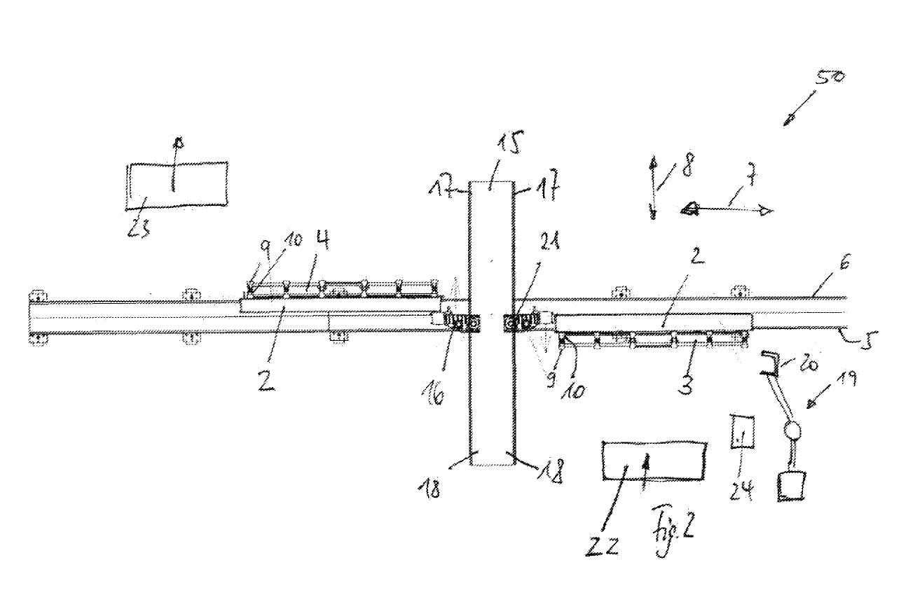

FIG. 2 shows a further exemplary embodiment of a machining device 50 which substantially corresponds to the machining device 1 of FIG. 1, wherein furthermore a second tool element 21 is provided which is arranged on the guide element 15 so as to be shiftable transversely with respect to the longitudinal direction 7. The second tool element 21 is likewise arranged shiftably on the guide element 15 in order to machine the workpiece 2. Said second tool element can be designed in the same manner as the first tool element, as described above. As a result, two workpieces 2 can also be machined simultaneously by means of the two tool elements 16, 21. The first tool element 16 and the second tool element 21 are guided shiftably on the guide element 15 in a manner spaced apart from each other in the longitudinal direction 7 such that the machining of the workpieces can be undertaken without any collision and the two tool elements 16, 21 are movable in direction 8 independently of each other.

According to the design of the manipulator device 19 of FIGS. 1 and 2, the manipulator device 19 is configured in such a manner that by means of the latter a workpiece 2 can be picked up from a workpiece feed 22, which is only indicated schematically, and can be fed to one of the workpiece tables 3, 4 into a clamping position 11, 12, 13, 14 in at least one clamping element 9, 10, or that by means of said manipulator device a workpiece 2 can be moved from a first clamping position 11, 12, 13, 14 in at least one first clamping element 9, 10 into a second clamping position 11, 12, 13, 14 in at least one second clamping element 9, 10, or by means of said manipulator device a workpiece 2 can be removed from a clamping position 11, 12, 13, 14 in at least one clamping element 9, 10 to a workpiece-removing means 23, which is likewise only illustrated schematically.

The manipulator device 19 is also configured here, in an advantageous development, in such a manner that by means of said manipulator device a workpiece 2 can be supplied to at least one tool element 24 for machining the workpiece 2. The tool element 24 can be arranged here as an additional assembly, for example also fixed in terms of space and immovable, in order, for example, to undertake drilling.

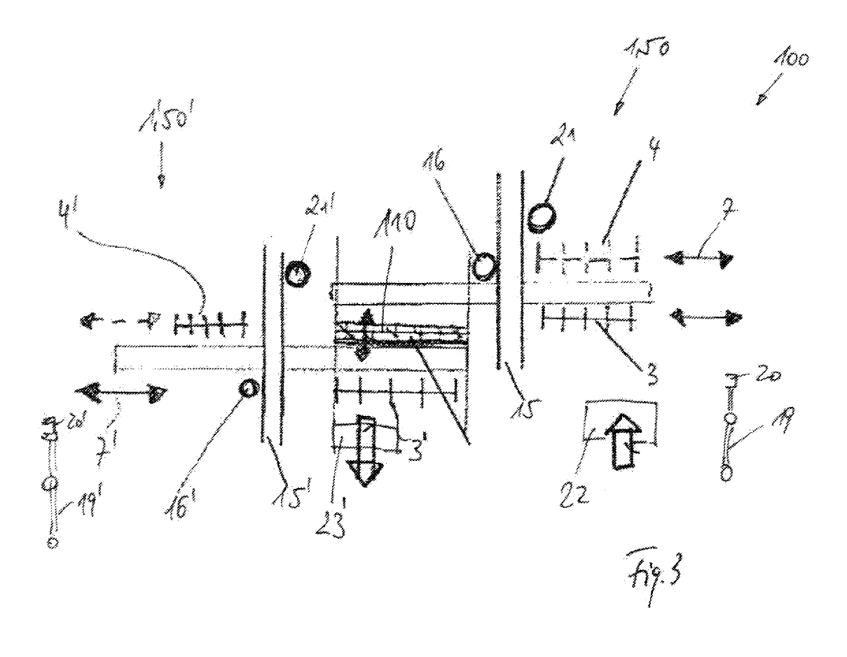

FIG. 3 shows, in a schematic illustration, a machining device 100 which is substantially designed as an arrangement of two machining devices 1 and 50 according to FIGS. 1 and 2. Two machining devices 1 or two machining devices 50 or in each case one machining device 1 and one machining device 50 can be provided here. The machining device 100 is therefore formed as a supplement of the machining devices 1 or 50 with at least one third workpiece table 3′ which is shiftable along a longitudinal direction and in particular with a fourth workpiece table 4′ which is shiftable in the longitudinal direction, wherein the two third and fourth workpiece tables 3′, 4′ are arranged spaced apart perpendicularly to the longitudinal direction 7′.

Each of the two third and fourth workpiece tables 3′, 4′ is in turn formed here with at least one clamping element or with clamping elements for clamping a workpiece 2, as has already been described with reference to FIGS. 1 and 2.

Furthermore, a second guide element 15′ is provided which is arranged oriented perpendicularly to the longitudinal direction and serves for the shiftable guiding of at least one tool element 16′, 21′.

Furthermore, it is optionally possible for a further manipulator device 19′ with at least one gripper 20′ to be provided corresponding to the manipulator device 19. However, the second manipulator device 19′ can also be replaced by the first manipulator device 19 which carries out the corresponding operations.

The second manipulator device 19′ is configured in such a manner that by means of the latter a workpiece 2 can be picked up from a workpiece feed 22 and can be supplied to either the third or fourth workpiece table 3′, 4′ in a clamping position in at least one clamping element or that by means of said manipulator device a workpiece can be moved from a first clamping position in at least one first clamping element into a second clamping position in at least one second clamping element, or by means of said manipulator device a workpiece can be removed from a clamping position in at least one clamping element to a workpiece-removing means.

FIG. 3 shows that a third manipulator device 110 is provided which is configured in such a manner that by means of the latter a workpiece from either the first or second workpiece table 3, 4 can be supplied to either the third or fourth workpiece table 3′, 4′, or that by means of said manipulator device a workpiece from either the third or fourth workpiece table 3′, 4′ can be supplied to either the second or third workpiece table 3, 4. The manipulator device 110 can also serve for removing a workpiece.

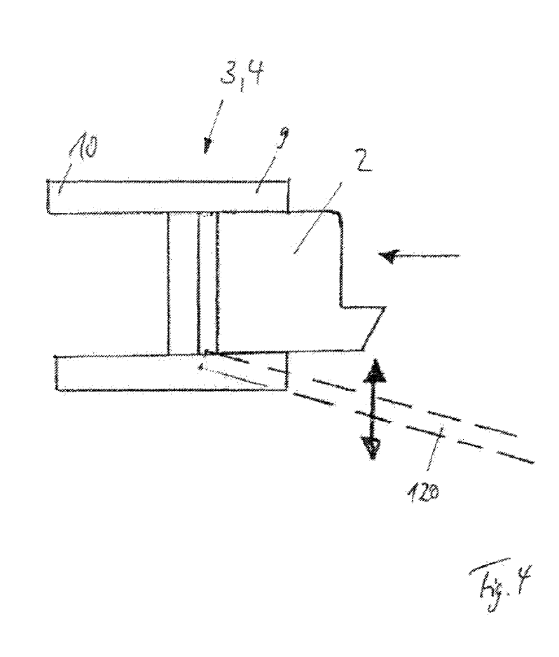

FIG. 4 shows, in a schematic illustration, a part of a workpiece table 3, 4 with the clamping elements 9, 10 in which a workpiece 2 is clamped. The workpiece-removing means 120 is designed here as a type of shute for the workpiece 2, onto which shute a workpiece 2 can be deposited such that it is removed in a sliding manner. For this purpose, the corresponding clamping element can be opened such that the workpiece 2 drops onto the shute and is thereby led in a sliding manner.

The machining devices 1, 50, 100 illustrated schematically according to the figures permit a method for operating a machining device for machining a workpiece 2, wherein a workpiece 2 can be machined in a clamping position of one of the workpiece tables 3, 4, 3′, 4′ by a tool element 16, 21, 16′, 21′, wherein substantially isochronously therewith a further workpiece 2 can be removed from one of the workpiece tables 3, 4, 3′, 4′ or can be supplied to one of the workpiece tables 3, 4, 3′, 4′ or can be moved in one of the workpiece tables 3, 4, 3′, 4′ from one clamping position into another clamping position or can be moved from one of the workpiece tables 3, 4, 3′, 4′ from one clamping position into another clamping position of another workpiece table 3, 4, 3′, 4′ by a manipulator device 19, 19′, or a further workpiece 2 can be machined in a clamping position of one of the other workpiece tables 3, 4, 3′, 4′ by means of another tool element.

In the case of the machining devices shown and described above, two or four workpiece tables are arranged in each case and are in turn arranged adjacent in pairs by means of rails. Alternatively thereto, more than two workpiece tables can also be arranged adjacent to one another and so as to be shiftable in the longitudinal direction by means of rails. In a corresponding manner, more than two tool elements can also be arranged on the guide devices, such as in particular one tool element per workpiece table.

### LIST OF REFERENCE SIGNS

1 Machining device
2 Workpiece
3, 3′ Workpiece table
4, 4′ Workpiece table
5 Rail
6 Rail
7, 7′ Longitudinal direction
8 Direction
9 Clamping element
10 Clamping element
11 Clamping position
12 Clamping position
13 Clamping position
14 Clamping position
15, 15′ Guide element
16, 16′ Tool element
17 Rail
18 Longitudinal side
19, 19′ Manipulator device
20 Gripper
21, 21′ Tool element
22 Workpiece feed
23 Workpiece-removing means
24 Tool element
50 Machining device
100 Machining device
110 Manipulator device
120 Workpiece-removing means

1. A machining device for workpieces, in particular made of wood, plastic or the like, with a first workpiece table which is shiftable along a longitudinal direction and with a second workpiece table which is shiftable in the longitudinal direction, wherein the two workpiece tables are arranged spaced apart perpendicularly to the longitudinal direction, wherein each of the two workpiece tables has clamping elements for clamping a workpiece, wherein the clamping elements are designed in such a manner that they have two clamping positions facing each other with respect to the longitudinal direction for clamping a workpiece, and therefore a workpiece can be clamped in the two clamping positions, and wherein furthermore a guide element is provided which is arranged oriented perpendicularly to the longitudinal direction and serves for the shiftable guiding of a tool element, with a first tool element which is arranged shiftably on the guide element, for machining the workpiece, with a first manipulator device for gripping and positioning a workpiece in at least one clamping element of one of the workpiece tables or for removing a workpiece from at least one clamping element of one of the workpiece tables.

2. The machining device as claimed in claim 1, wherein a second tool element is provided which is arranged shiftably on the guide element, for machining the workpiece.

3. The machining device as claimed in claim 2, wherein the first tool element and the second tool element are guided shiftably on the guide element in a manner spaced apart from each other in the longitudinal direction.

4. The machining device as claimed in claim 2, wherein the first tool element and the second tool element are guided shiftably on the guide element at the same height in the longitudinal direction.

5. The machining device as claimed in claim 1, wherein the guide element is a gantry or an extension arm on which the first and/or the second tool element are shiftably guided.

6. The machining device as claimed in claim 1, wherein the first manipulator device is configured in such a manner that by means of the latter a workpiece can be picked up from a workpiece feed and can be supplied to one of the workpiece tables into a clamping position in at least one clamping element, or by means of said manipulator device a workpiece can be moved from a first clamping position in at least one first clamping element into a second clamping position in at least one second clamping element, or by means of said manipulator device a workpiece can be removed from a clamping position in at least one clamping element to a workpiece-removing means.

7. The machining device as claimed in claim 6, wherein the first manipulator device is configured in such a manner that by means of the latter a workpiece can be supplied to at least one tool element for machining the workpiece.

8. A machining device in particular as claimed in claim 1, with at least one third workpiece table which is shiftable along a longitudinal direction and in particular with a fourth workpiece table which is shiftable in the longitudinal direction, wherein the two third and fourth workpiece tables are arranged spaced apart perpendicularly to the longitudinal direction, wherein each of the two third and fourth workpiece tables have clamping elements for clamping a workpiece, wherein the clamping elements are designed in such a manner that they have two clamping positions facing each other with respect to the longitudinal direction for clamping a workpiece, and therefore a workpiece can be clamped in the two clamping positions, and wherein furthermore a second guide element is provided which is arranged oriented perpendicularly to the longitudinal direction and serves for the shiftable guiding of at least one tool element, with a third tool element which is arranged shiftably on the second guide element, for machining the workpiece, with a second manipulator device for gripping and positioning a workpiece in at least one clamping element of either the third or fourth workpiece table or for removing a workpiece from at least one clamping element of either the third or fourth workpiece table.

9. The machining device as claimed in claim 8, wherein the second manipulator device is the first manipulator device, or the second manipulator device is an additional manipulator device which is separate from the first manipulator device.

10. The machining device as claimed in claim 8, wherein a fourth tool element is provided which is arranged shiftably on the second guide element, for machining the workpiece.

11. The machining device as claimed in claim 10, wherein the third tool element and the fourth tool element are guided shiftably on the second guide element in a manner spaced apart from each other in the longitudinal direction.

12. The machining device as claimed in claim 1, wherein the second guide element is a gantry or an extension arm on which the third and/or the fourth tool element are shiftably guided.

13. The machining device as claimed in claim 1, wherein the second manipulator device is configured in such a manner that by means of the latter a workpiece can be picked up from a workpiece feed and can be supplied to either the third or fourth workpiece table in a clamping position in at least one clamping element, or by means of said manipulator device a workpiece can be moved from a first clamping position in at least one first clamping element into a second clamping position in at least one second clamping element, or by means of said manipulator device a workpiece can be removed from a clamping position in at least one clamping element to a workpiece-removing means.

14. The machining device as claimed in claim 8, wherein a third manipulator device is provided which is configured in such a manner that by means of the latter a workpiece from either the first or second workpiece table can be supplied to either the third or fourth workpiece table, or by means of said manipulator device a workpiece from either the third or fourth workpiece table can be supplied to either the second or third workpiece table, or by means of said manipulator device a workpiece can be moved from a first clamping position in at least one first clamping element into a second clamping position in at least one second clamping element, or by means of said manipulator device a workpiece can be removed from a clamping position in at least one clamping element to a workpiece-removing means.

15. The machining device as claimed in claim 1, wherein the workpiece-removing means contains a shute for the workpiece, onto which shute a workpiece can be deposited such that it is removed.

16. A method for operating a machining device in particular as claimed in claim 1, in particular for machining a workpiece, wherein a workpiece can be machined in a clamping position of one of the workpiece tables by a tool element, wherein substantially isochronously therewith a further workpiece can be removed from one of the workpiece tables or can be supplied to one of the workpiece tables or can be moved in one of the workpiece tables from one clamping position into another clamping position, or can be moved from one of the workpiece tables from one clamping position into another clamping position of another workpiece table by a manipulator device, or a further workpiece can be machined in a clamping position of one of the other workpiece tables by means of another tool element.
